(19) United States
(12) Patent Application Publication
(10) Pub. No.: US 2024/0410492 A1
(43) Pub. Date: Dec. 12, 2024

(54) HOSE BIB HANDLE REPLACEMENT ADAPTER

(71) Applicant: Kevin Albrecht, Chino Hills, CA (US)

(72) Inventor: Kevin Albrecht, Chino Hills, CA (US)

(21) Appl. No.: 18/665,499

(22) Filed: May 15, 2024

Related U.S. Application Data
(60) Provisional application No. 63/466,631, filed on May 15, 2023.

(51) Int. Cl. F16K 31/60

(52) U.S. Cl. CPC F16K 31/60; F16K 31/607

(57) ABSTRACT

A hose bib handle replacement adapter has an adapter body with a top having an opening, a bottom having an opening, and a passageway extending through the adapter body from the top opening to the bottom opening. The passageway includes an interior cavity at the bottom end of the adapter body, the interior cavity being sized to at least partially receive a broach of a hose bib, wherein the interior wall of the interior cavity is tapered to accommodate different sized broaches. The passageway is adapted to receive a threaded broach connector that has been inserted into the top opening and inserted into a broach threaded opening when the broach is received in the interior cavity of the adapter body. A hose bib handle replacement system and method are also described.

### PRIORITY

The present application claims the benefit of domestic priority based on U.S. Provisional Patent Application 63/466,631 filed on May 15, 2024, the entirety of which is incorporated herein by reference.

### BACKGROUND

No one likes having to call a plumber. It is expensive, stressful, and time consuming. However, many plumbing issues are too complicated or difficult for the do-it-yourselfer because they require know-how, tools, and/or specific parts. This can be particularly frustrating for tasks that seem like they should be easy to do without the need for a professional.

An example of a seemingly simple task that is heretofore anything but simple is the replacement of a faucet handle, such as a hose bib handle. Traditional faucets include at least one faucet handle which is rotated to open and close a valve for controlling the flow of water to a delivery spout. The faucet handle is coupled to the valve stem. When the faucet handle needs to be replaced, finding a faucet handle which will fit into the existing valve stem is cumbersome due to the various shapes and sizes of the valve stem, such as square, round, threaded, metric, standard, keyhole etc. Furthermore, the threaded and welded attachments of the hose bib often require complete replacement of the hose bib, and plumbing knowledge to be able to replace the handle with a new handle.

Existing hose bib adapters suffer from various disadvantages. For example, replacement faucet handles may not be sufficiently decorative. A replacement system is disclosed in U.S. Pat. No. 10,655,751 which provides for the replacement of a hose bib handle and which is incorporated herein by reference in its entirety. While the system disclosed in U.S. Pat. No. 10,655,751 is particularly useful and offers numerous advantages over the prior art, the system can sometimes be susceptible to handle loosening and/or may not be easily installable onto faucets that have a collar around the broach of the faucet.

Therefore, there is a need for an improved hose bib handle replacement adapter or system. There is further a need for a hose bib handle replacement adapter or system that is easy and effective to use. There is a further need for a hose bib handle replacement dapter or system that prevents the handle from rotation relative to the hose bib. There is a further need for a hose bib handle replacement system that prevents the handle from rotation relative to the hose bib and that is installable onto a hose bib with a collar. There is a further need for a hose bib handle replacement system that prevents the handle from rotation relative to the hose bib and that is connectable to various sizes, shapes, and designs of hose bibs or other faucets.

### SUMMARY

The present invention satisfies these needs. In one aspect of the invention, an improved hose bib handle replacement adapter or system is provided.

In another aspect of the invention, a hose bib handle replacement system includes an adapter that helps prevent rotation of the replacement handle.

In another aspect of the invention, a hose bib handle replacement system includes an adapter that helps prevent rotation of the replacement handle and that is installable onto a hose bib that has a frost-prevention collar.

In another aspect of the invention, a hose bib handle replacement system includes an adapter that helps prevent rotation of the replacement handle and that is connectable to various sizes shapes, and designs of hose bibs.

In another aspect of the invention, a hose bib handle replacement adapter comprises an adapter body comprising a top having an opening, a bottom having an opening, and a passageway extending through the adapter body from the top opening to the bottom opening, wherein the passageway includes an interior cavity at the bottom end of the adapter body, the interior cavity being sized to at least partially receive a broach of a hose bib, wherein the interior wall of the interior cavity is tapered to accommodate different sized broaches, and wherein the passageway is adapted to receive a threaded broach connector that has been inserted into the top opening and inserted into a broach threaded opening when the broach is received in the interior cavity of the adapter body.

In another aspect of the invention, a hose bib handle replacement system comprises a replacement handle adapted to be releasably connected to an adapter; an adapter having an adapter body comprising a top having an opening, a bottom having an opening, and a passageway extending through the adapter body from the top opening to the bottom opening, wherein the passageway includes an interior cavity at the bottom end of the adapter body, the interior cavity being sized to at least partially receive a broach of a hose bib, wherein the passageway is adapted to receive a threaded broach connector that has been inserted into the top opening and inserted into a broach threaded opening when the broach is received in the interior cavity of the adapter body; and a connection mechanism adapted to releasably connect the replacement handle to the adapter body, wherein the connection mechanism comprises one or more set screws, one or more threaded openings through a portion of the replacement handle or the adapter body, and a surface on the other of the replacement handle and the adapter body, wherein the surface is adapted to be contacted by an end surface of the one or more set screws to connect the replacement handle to the adapter, and wherein the surface comprises one or more recesses adapted to cooperate with the set screw to prevent rotation between the adapter and the replacement handle when the replacement handle is connect to the adapter.

In another aspect of the invention, a method of installing a hose bib handle comprises providing a handle adapted to be connected to a hose bib; providing an adapter having an adapter body comprising a top having an opening, a bottom having an opening, and a passageway extending through the adapter body from the top opening to the bottom opening, wherein the passageway includes an interior cavity at the bottom end of the adapter body, the interior cavity being sized and shaped to at least partially receive a broach of a hose bib in a manner that different sized broaches can be received; positioning the adapter on a broach so that the broach is at least partially receiving in the interior cavity; inserting a threaded broach connector into the passageway and into a threaded broach opening to connect the adapted to the broach; and connecting the handle to the adapter body.

### DRAWINGS

These features, aspects, and advantages of the present invention will become better understood with regard to the following description, appended claims, and accompanying drawings which illustrate exemplary features of the invention. However, it is to be understood that each of the features can be used in the invention in general, not merely in the context of the particular drawings, and the invention includes any combination of these features, where:

FIG. 1 is a schematic exploded perspective view of a hose bib handle replacement system of the present invention and a hose bib;

FIG. 2A is a schematic exploded perspective view of a portion of an adapter and handle of a version of a hose bib handle replacement system of the invention;

FIG. 2B is a schematic sectional view of the adapter and handle of FIG. 2A when connected;

FIG. 2C is a schematic exploded, perspective view of a portion of an adapter and handle of another version of a hose bib handle replacement system of the invention;

FIG. 2D is a schematic sectional view of the adapter and handle of FIG. 2C when connected;

FIG. 3A is a schematic exploded perspective view of a portion of an adapter and handle of another version of a hose bib handle replacement system of the invention;

FIG. 3B is a schematic sectional view of the adapter and handle of FIG. 3A when connected;

FIG. 3C is a schematic exploded perspective view of a portion of an adapter and handle of another version of a hose bib handle replacement system of the invention;

FIG. 3D is a schematic sectional view of the adapter and handle of FIG. 3C when connected;

FIG. 4A is a side view of a portion of an adapter and handle of another version of a hose bib handle replacement system of the invention;

FIG. 4B is a schematic perspective view of the adapter of FIG. 4A;

FIG. 5 is a schematic exploded perspective view of a version of an adapter of a hose bib handle replacement system of the invention and a hose bib;

FIG. 6 is a schematic exploded perspective view of another version of an adapter of a hose bib handle replacement system of the invention and a hose bib;

FIG. 7 is a schematic exploded perspective view of another version of an adapter of a hose bib handle replacement system of the invention and a hose bib;

FIG. 8 is a schematic exploded perspective view of another version of an adapter of a hose bib handle replacement system of the invention and a hose bib;

FIG. 9A is a schematic side view of another version of an adapter of a hose bib handle replacement system of the invention and a hose bib;

FIG. 9B is a schematic side view of another version of an adapter of a hose bib handle replacement system of the invention and a hose bib;

FIG. 10A is a schematic perspective top view of a version of an adapter of a hose bib handle replacement system of the invention;

FIG. 10B is a schematic side view of the adapter of FIG. 10A;

FIG. 10C is a schematic perspective bottom view of the adapter of FIG. 10A;

FIG. 10D is a schematic bottom view of the adapter of FIG. 10A; and

FIG. 11 is a schematic exploded perspective view of a hose bib handle replacement system of the invention with the adapter of FIG. 10A and a hose bib.

### DESCRIPTION

The present invention relates to a universal hose bib handle replacement system. In particular, the invention relates to a universal hose bib adapter for easily and more universally replacing a handle on a hose bib. Although the invention is illustrated and described in the context of being useful with an outdoor faucet or outside spigot, the present invention can be used in other ways, as would be readily apparent to those of ordinary skill in the art. Accordingly, the present invention should not be limited just to the examples and embodiments described herein.

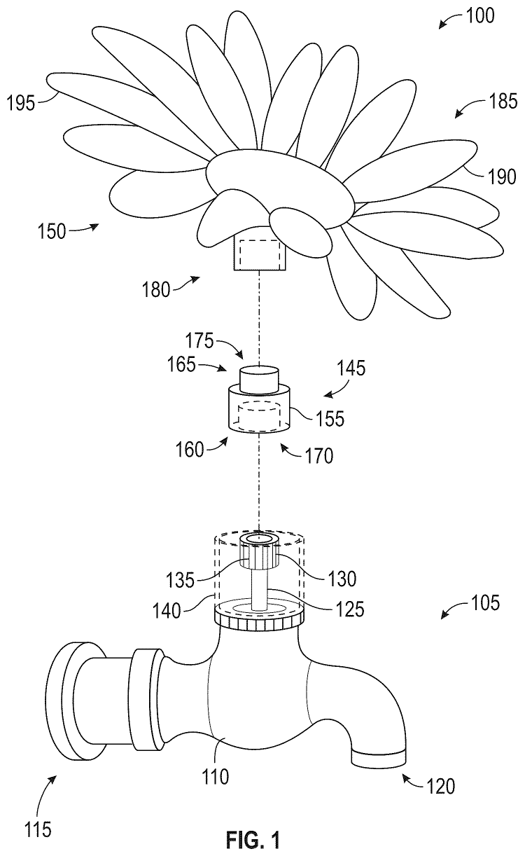

FIG. 1 shows a hose bib handle replacement system 100 according to one version of the invention in association with a hose bib 105 in need of a handle. The hose bib 105, also known as a hose bib, an outside spigot, and an outdoor faucet, tap, or tap handle has a body 110 and is attached at a first end 115 to a water line that is connected to a source of water, such as a community water line, a well, or the like. Water can flow through the body 110 to an outlet 120 of the hose bib 105. The outlet 120 may be provided with a connector, such as threads, whereby a hose or the like may be connected to the outlet 120. Within the body 110 a valve (not shown) is provided that selectively allows and prevents the flow of water from the first end 115 to the outlet 120. The opening and closing of the valve is controlled by rotation of a stem 125 extending from the top of the body 110 of the hose bib 105. The stem 125 can include a broach 130 which is a portion of the stem 125 that connects to another structure. Sometimes the stem and the broach are referred to collectively as the stem or as the broach, and sometimes the terms are used interchangeably. Conventionally, a handle is provided with the hose bib 105 that mates with the broach 130 to further facilitate turning of the broach 130 and thus subsequent opening and closing of the valve depending on the direction the broach 130 and stem 125 are rotated. Vertical knurls 135, such as projections, recesses, and/or other friction enhancing surface treatment, are often provided on the broach 130 to help provide a better grip with the handle. Numerous stem 125 and broach 130 designs are available, and each design uses a corresponding handle designed specifically for each stem 125 and broach 130 design. Thus, handles designed for one type of stem 125 and broach 130 are generally not compatible with another design. For example, the various stem 125 and broach 130 designs can vary in length, cross-sectional dimension, and/or cross-sectional shape. In the version of FIG. 1, the broach 130 has a generally circular cross-sectional shape. Some hose bibs 105 are equipped with a collar 140, such as a frost-prevention collar, as shown in phantom in FIG. 1. When provided, the collar 140 at least partially surrounds or covers at least a portion of the stem 125 or broach 130 making it difficult to access the lateral periphery of the broach 130.

In one version of the invention, the handle replacement system 100 of the invention comprises an adapter 145 that is to provide for universal connection of a handle 150, such as a replacement handle, for the hose bib 105. The adapter 145 and handle 150 can be separate parts, connectable parts, or integrally connected parts, as will be described. In the version of FIG. 1, the adapter 145 of the handle replacement system 100 is designed to allow for universal replacement of a handle 150 onto a hose bib 105 whether or not the hose bib 105 is equipped with a collar 140. In other versions, as described hereinbelow, the adapter 145 may be designed to additional or alternatively provide universal connection to various stem 125 and broach 130 designs, such as with broaches having different cross-sectional sizes or shapes. By universal, it is meant that adapter 145 is designed to work with a plurality of different hose bibs, such as a first hose bib that does not have a collar 140 and a second hose bib that is equipped with a collar 140, and/or a plurality of different broaches 130, such as a first broach 130 having one shape and a second hose bib 130 having a second shape and/or a first broach 130 having a first cross-sectional dimension and a second broach 130 having a second cross-sectional dimension. Alternatively, the handle replacement system 100 of the invention can have an adapter 145 designed to fit a particular stem 125 and broach 130 design.

The adapter 145 of the handle replacement system 100 has an adapter body 155 having a broach connecting portion 160 and a handle connecting portion 165. The broach connecting portion 160 is designed to connect to the broach 130 by a broach connecting mechanism 170, as will be described. In the version shown in FIG. 1, the broach connecting mechanism 170 is designed to be able fit onto the broach 130 whether or not a collar 140 is provided on the hose bib 105, making the adapter 145 universally usable with either form of hose bib 105. The handle connecting portion 165 is connectable to the handle 150 either by a handle connecting mechanism 175 that is connectable to a connection member 180 of the handle 150 of the type to be described or by any other suitable connection, such as by being attached by a screw or other connector or by being permanently connected, such as by a weld. The handle connection mechanism 175, whether it be a releasable connection or a permanent connection, is designed to prevent relative rotation between the handle 150 and the adapter 145.

The handle 150 of the replacement handle system 100 can be a conventional spigot handle or any other design. For example, the handle 150 can have a decorative design 185 such as the flower design 190 shown in FIG. 1. The conventional or decorative design 185 serves the purpose of increasing the radius of the handle 150 thereby increasing the moment for applying torque. In the flower design 190 version, the petals 195 serve as moment increasers. In one version, the handle 150 has a radial dimension that is larger than the longest radial dimension of the adapter 145, more preferably at least two times longer, and more preferably at least three times longer. By radial dimension it is meant a dimension extending radially outwardly from an axis passing through the center of the adapter 145 and/or the stem 125 or broach 130 of the hose bib when the adapter 145 is attached to the broach 130 and along a plane that is perpendicular to that axis.

The adapter 145 of the hose bib handle replacement system 100 is design to allow torsion applied to the handle portion 150 to be transmitted to the broach connecting portion 160 and then from the broach connecting portion 160 to the broach 130. Accordingly, by rotation of the handle 150 a user can control or operate the valve of the hose bib 105. The broach connecting mechanism 170 and the handle connecting mechanism 175 of the adapter 145 are designed and adapted to prevent relative rotation between the handle broach 130 and the adapter 145 and between the handle 150 and the adapter 145, respectively. One or more of the broach connecting mechanism 170 and the handle connecting mechanism 175 may also be designed for convenient replacement by providing a releasable connection.

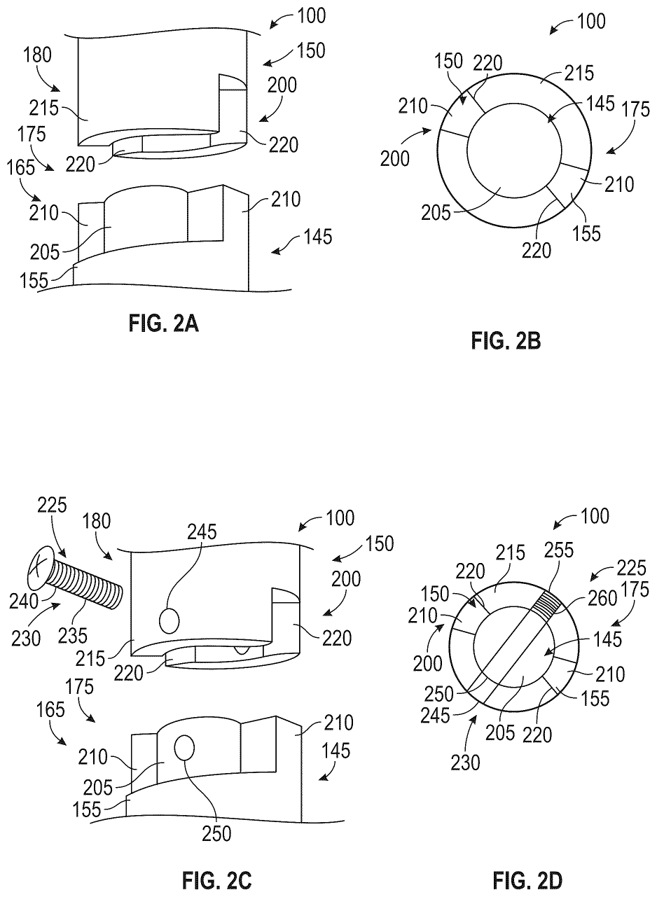

FIG. 2A shows a version of an adapter 145 with a handle connecting mechanism 170. In this version, the handle connection mechanism 175 includes a chocking mechanism 200. In the particular version shown, the chocking mechanism 200 includes a shaft portion 205 on the adapter 145 or the handle 150 that includes one or more outwardly extending protrustions 210. In the particular version shown in FIG. 2A, the shaft portion 205 is on the adapter 145, but it is to be understood that the arrangement, along with all arrangement described herein, can be reversed. The shaft portion 205 of the handle connecting portion 165 of the adapter 145 is a male member that is receivable within an at least partially hollow female member 215 that makes up part of the connection member 180 of the handle 150. The female member 215 includes one or more slots 220 that correspond to the one or more protrusions 210 so as to receive the one or more protrusions 210 in a keyed manner that helps prevent the handle connecting member 180 from rotating relative to the adapter 145. When connected, as shown in the cross-section of FIG. 2B, the handle connecting mechanism 175 allows the handle 150 and the adapter 145 to turn as a unit, and when the broach connecting mechanism 170 is connected to a broach 130, the broach 130 is then turnable by turning the handle 150.

The handle connecting mechanism 175 of the adapter 145 and handle 150 can be designed so that the adapter 145 and the handle 150 are releasably connectable, releasably secured to one another, or permanently secured to one another, such as by welding or adhesive. For example, in the version of FIG. 2A, the handle connecting mechanism 175 may be releasably connectable by being loosely slideable thereon. In this manner, a user can install the handle 150 onto the adapter 145 when it is desired to rotate the adapter 145 and valve of the hose bib 105. The handle 150 can be more secured to the adapter 145 by using a releasably secureable connection mechanism 225, such as shown in FIG. 2B. The releasably secureable connection mechanism 225 includes a securing mechanism 230 that helps to hold the handle 150 onto the adapter 145 during use and when not in use while allowing for selective release. In the version of FIG. 2B, the securing mechanism 230 is in the form of a transverse shaft 235 that may or may not be a threaded member 240, such as a screw or bolt, that is insertable through a handle transverse opening 245 in the female member 215 of the connection member 180 of the handle 150. An adapter transverse opening 250 may also be provided that is alignable with handle transverse opening 240, as shown in the cross-section of FIG. 2D. Optionally, a second handle transverse opening 255 may be provided, which may optionally be a threaded opening 260 with threads that engage the threads on the threaded member 240. The transverse shaft 235 is not shown in FIG. 2D for clarity.

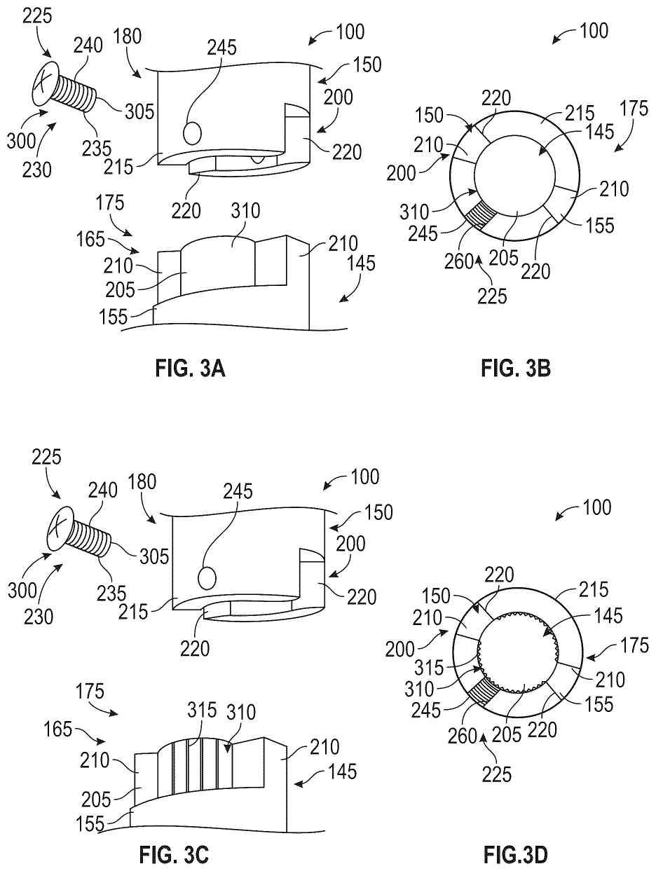

Another version of a securing mechanism 230 of a releasably securable connection mechanism 225 of the handle connecting mechanism 175 of the adapter 145 is shown in FIGS. 3A and 3B. In the version of FIGS. 3A and 3B, the handle transverse opening 245 is a threaded opening 260 and the transverse shaft 235 is in the form of a set screw 300 that includes an end surface 305 that is adapted to be screwed into the threaded opening 260 until the end surfaces presses against an outer surface 310 of the shaft portion 205 of the adapter 145. When sufficient pressure, the set screw 300 can hold the adapter 145 and handle 150 together. In another version, a plurality of threaded openings 260 and corresponding set screws 300 may be provided. In one particular version, three threaded openings 260 and three set screws 300 are provided and substantially even spaced around the periphery of the handle connecting mechanism 175. FIGS. 3C and 3D show another version of the securing mechanism 230 similar to the version of FIGS. 3A and 3B, but in the version of FIGS. 3C and 3D, a surface texture 315 to help to improve the grip between the end surface 305 of the set screw 300 and the outer surface 310 of the shaft portion 205. The transverse shaft 235 is not shown in FIGS. 3B and 3D for clarity.

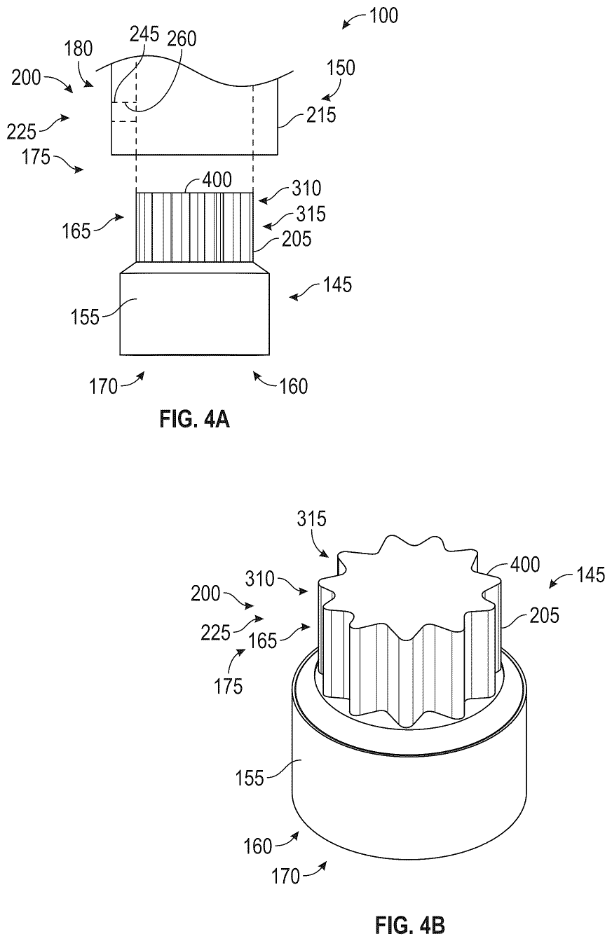

FIGS. 4A and 4B show another version of releasably securable connection mechanism 225 of the handle connecting mechanism 175 of the adapter 145. In this version, the surface texture 315 of the outer surface 310 of the shaft portion 205 includes one or more recesses 400, such as a cavity or channel, that are provided on the outer surface 310 of the shaft portion 205 and are designed to receive or engage the end surface 305 of the set screw 300 in a manner that provides additional prevention of rotation between the adapter 145 and the handle 150. Optionally the end surface 305 of the set screw 300 can be shaped to or can include a projection that is shaped to extend into and optionally match the contour of a recess 315. In another version, a plurality of threaded openings 260 and set screws 300 can be provided in the version of FIGS. 4A and 4B and can serve as an additional or alternative chocking mechanism 200 to the protrusions 210 and slots 220. In the particular version shown in FIGS. 4A and 4B, a three set screw arrangement with three threaded openings 260 spaced 120 degrees apart is provided as the chocking mechanism 200 and is particularly effective at both releasably securing the handle 150 to the adapter 145 and preventing rotation. The transverse shaft 235 is not shown in FIG. 4A for clarity.

Before or after the handle 150 is connected to the adapter 145, the adapter 145 can be connected to the broach 130 or other portion of the stem 125 or otherwise communicate with the valve within the hose bib 105. In one version, the broach connecting mechanism 170 that connects the broach connecting portion 160 of the adapter 145 to the broach 130 can be as described in U.S. Pat. No. 10,655,751, which is incorporated herein by reference, or by other similar mechanism. In another version, the broach connecting mechanism 170 can be in accordance with one or more of the designs described herein.

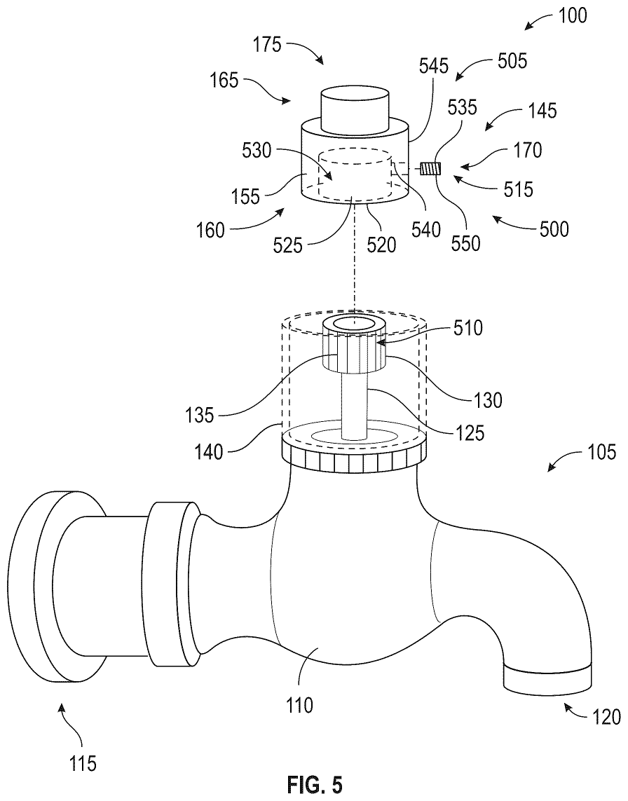

FIG. 5 shows a version of an adapter 145 of a hose bib handle replacement system 100 of the invention. In this version, the adapter 145 includes a broach connecting mechanism 170 similar in some aspects as the system described in U.S. Pat. No. 10,655,751. In this version, the broach connecting mechanism 170 includes a clamping mechanism 500 that allows the adapter 145 to clamp onto the broach 130 of the hose bib 105. The clamping mechanism 500 allows torque to be transferred from the adapter 145 to the broach 135 so that rotation of the adapter 145 causes rotation of the broach 130 or stem 125.

In the version of FIG. 5, the clamping mechanism 500 is a transverse clamping mechanism 505 that allows the adapter 145 to clamp onto a side surface 510 of the broach 130. The transverse clamping mechanism 505 includes one or more clamping members 515 that adjustably engage the side surface 510 of the broach 130 of the hose bib 105. In this version, the adapter 145 has a bottom 520 with an opening 525 into an interior cavity 530 of the adapter 145 or the broach connecting portion 160 of the adapter 145. The interior cavity 530 is in the form of a cavity that is sized and shaped to receive at least a portion of the broach 130. The adapter 145 is slid over the broach 130 so that the broach 130 is received within the interior cavity 530 of the adapter 145. The one or more clamping members 515 then can lockingly engage the broach 130 so that the adapter 145 is clamped onto the broach 130. In one version, the interior has a radial dimension at the bottom 520 of from about 0.3 to about 0.7 inches in diameter or cross-sectional width, more preferably from about 0.4 to about 0.5 inches in diameter or cross-sectional width. In one version, the one or more clamping members 515 can include one or more broach set screws 535 or anchor screws, and more preferably a plurality of such broach set screws 535. Each set screw 535 is receivable in a side opening 540 of the adapter 145. Each side opening 540 extends from an outer wall 545 of the adapter 145 to the interior cavity 530 and includes threads that can engage threads 550 on the broach set screw 535. As the broach set screw 535 is rotated in a first rotational direction, it advances within the side opening 540, and as it is rotated in the opposite direction, the broach set screw 535 withdraws from the side opening 540. In use, each broach set screw 535 is advanced until a forward end 550 of the broach set screw 535 contacts and engages the side surface 510 of the broach 130. A particular version of the adapter 145 has three side openings 540 for receiving three broach set screws 535. Preferably, the three side openings 540 are positioned equal distance from one another around the outer wall 545. Accordingly, for a cylindrically shaped outer wall 545, the three side openings 540 are each about 120 degrees from one another. This arrangement allows the broach set screws 535 to clamp onto the broach 130 in equal and harmonizing fashion to help provide a strong clamp and to help reduce relative rotation between the parts. Alternatively, there can be more side openings 540 that are equally spaced. While the outer wall 545 is cylindrical in the version shown, it can take on any other shape. By “120 degrees” and the other angles, it is meant the angle of the openings and/or inserted set screws relative to one another.

As shown in the version of FIG. 5, the adapter 145 can be designed and configured to be used with a hose bib 105 having a frost-prevention collar 140. With the adapter disclosed in U.S. Pat. No. 10,655,751, it has been discovered that installation of the adapter can be difficult when being inserted onto a hose bib 105 with a frost-prevention collar 140. Accordingly, in the version of FIG. 5, the broach set screw 535 is preinserted into a side opening 540 prior to the adapter being installed onto the broach 130. In addition, the length of the broach set screw 535 is sufficiently short that it does not extend beyond the outer wall 540 even prior to tightening. To clamp the broach set screw 535 onto the broach 130 after the adapter 145 is positioned so that the broach 130 is received within the interior cavity 530, an angled tool, such as a 90 degree angled Allen wrench or hex hey, can be used. In this way, the adapter 145 of FIG. 5 can be installed onto a hose bid 105 having a frost-prevention collar 140 so long as the outer dimension of the outer wall 545 is sufficiently small to allow enough of a gap between the outer wall 545 and the frost-prevention collar 140 to the insertion of the angled tool.

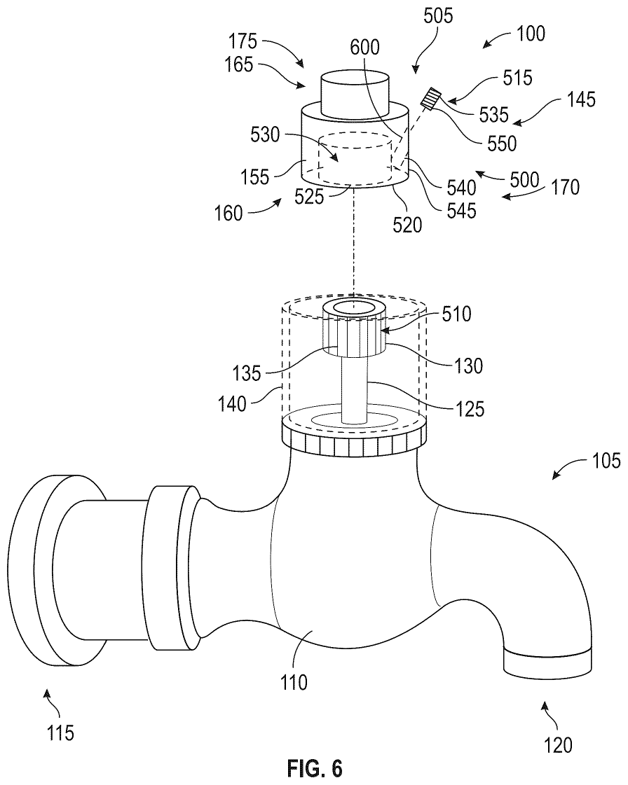

Another version of an adapter 145 designed and configured to be used with a hose bib 105 having a front-prevention collar 140 is shown in FIG. 6. The version of FIG. 6 is particularly useful when the outer dimension of the outer wall 545 is not sufficiently small to allow enough of a gap between the outer wall 545 and the frost-prevention collar 140 to the insertion of the angled tool. In the version of FIG. 6, the transversion clamping mechanism 505 includes an angled side opening 600. The angled side opening 600 is accessible by a tool from above the frost-prevention collar 140.

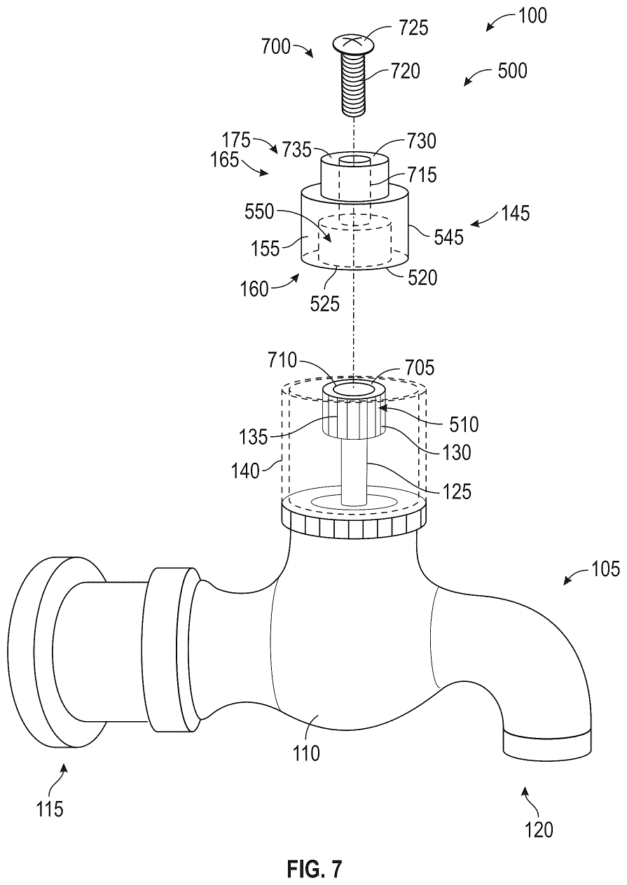

Another version of an adapter 145 designed and configured to be used with a hose bib 105 having a front-prevention collar 140 is shown in FIG. 7. The version of FIG. 6 is particularly useful when the outer dimension of the outer wall 545 is not sufficiently small to allow enough of a gap between the outer wall 545 and the frost-prevention collar 140 to the insertion of the angled tool or for access to an angled side opening 600. The version of FIG. 7 comprises a broach connecting mechanism 170 that has a top connecting mechanism 700. The top connecting mechanism connects to the top 705 of the broach 130 or stem 125. The top 705 of the broach 130 includes a threaded broach opening 710. The adapter body 155 of the adapter 145 includes a longitudinal passageway 715 that extends from a top opening. By longitudinal it is meant that the passageway extends in the direction of the broach 130 or stem 125 when the adapter 145 is connected to the broach 130. A threaded broach connector 720, such as a screw or bolt, is insertable through the longitudinal passageway 715 and into the threaded broach opening 710 when the broach 130 is received within the interior cavity 530. As can be seen, in this version, the interior cavity 530 is included with or forms a portion of the passageway 715. A head 725 of the threaded broach connector 720 contacts a seating surface 730 on the adapter body 155, such as the top surface 735 of the adapter body 155 or an inset surface within the adapter body 155. Upon rotation of the threaded broach connector 720, the threaded broach connector 720 advances within the threaded broach opening 710 and the adapter 145 is clamped onto the broach 130 by the downward force of the head 725 on the seating surface 730. Alternatively, the threaded broach connector 720 can be inserted into the threaded broach opening 710 to connect the two parts without clamping them. The threaded broach connector 720 can be a broach screw that is present in the broach 130 at the time of the handle replacement or can be a separate screw or bolt that is provided with the adapter 145.

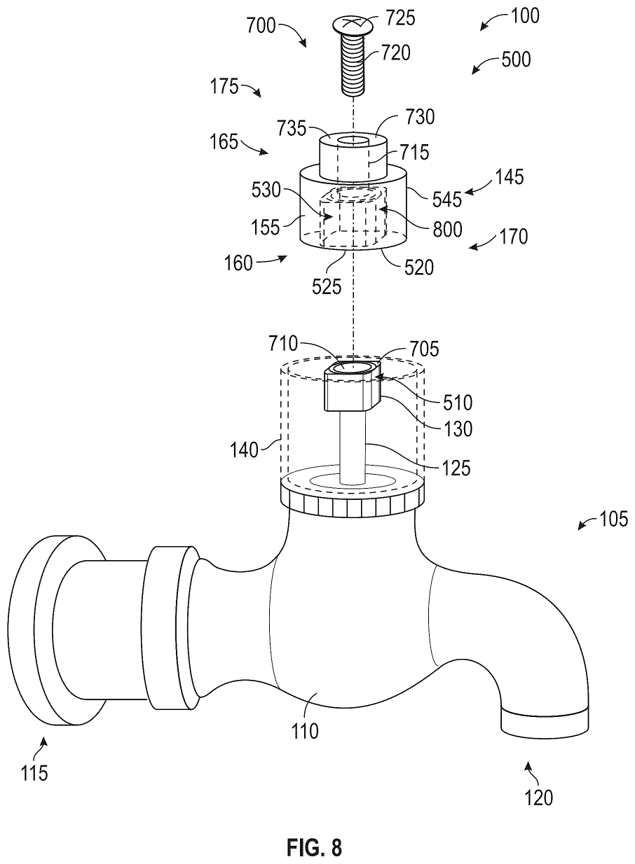

In the versions of FIGS. 5, 6, and 7, the interior cavity 530 of the adapter 145 is shown as being generally circular in cross section in order to generally match the shape of a broach 130 having a generally circular cross-section. However, the interior can be differently shaped to generally match other shapes of broaches. For example, FIG. 8 shows a version of an adapter 145 similar to FIG. 8 but with an interior cavity 530 has a non-circular cross-sectional shape 800 to more closely match a square or rectangular cross-section broach 130.

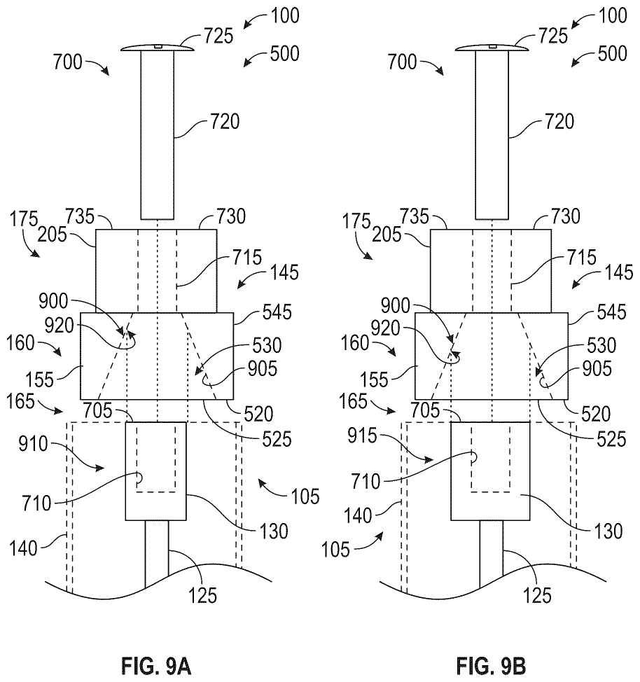

FIG. 9A and 9B show another version of an adapter 145 similar to the version of FIG. 7 but with an interior cavity 530 designed and shaped to make the adapter 145 universally useable with different cross-sectional dimensioned broaches 130. In the version shown, the interior cavity 530 is a tapered interior 900 that has an interior wall 905 that increased in cross-sectional dimension from top to bottom. The amount taper is shown to an exaggerated amount in FIG. 9A and 9B to more clearly illustrate the universality of the design. As can be seen, the adapter 145 can be easily clamped onto either a smaller cross-section broach 910 as shown in FIG. 9A or a larger cross-section broach 915 as shown in FIG. 9B. The smaller broach 910 will contact the interior wall 905 at a contact position 920 closer to the top of the adapter 145 than the larger broach 915. The threaded broach connector 720 clamps the adapter 145 onto the broach 130 no matter the cross-sectional dimension. In one version, the amount of taper of the interior wall 905 from the top of the interior cavity 530 to the bottom of the interior cavity 530 is from about 0.25 mm to about 4 mm, or from about 0.5 mm to about 2 mm, and in one particular version is about 1 mm.

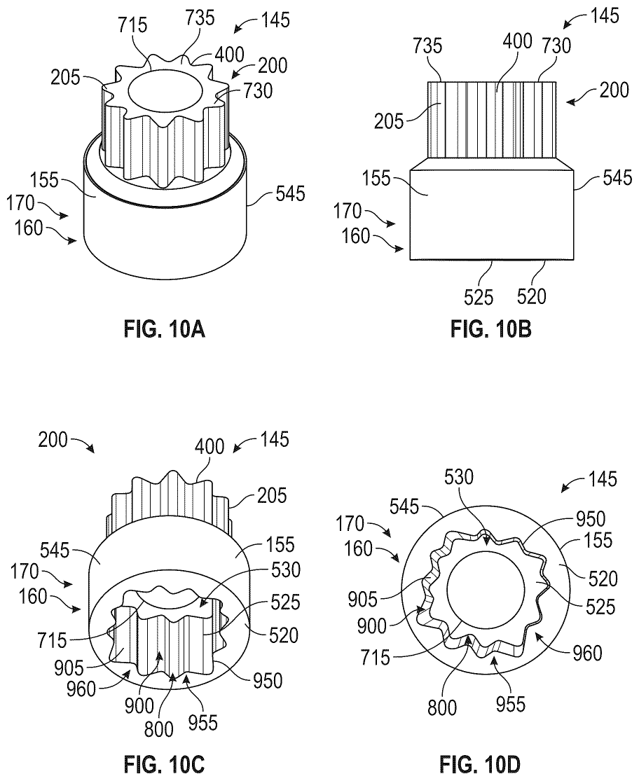

FIGS. 10A, 10B, 10C, and 10D show a version of an adapter 145 of the invention. The adapter 145 of the version of FIGS. 10A, 10B, 10C, and 10D, includes a handle connecting mechanism 175 with a releasably securable connection mechanism 225 of the type shown in FIGS. 4A and 4B and a broach connecting mechanism 170 with a top connecting mechanism 700 and with a tapered interior 900. In addition, the interior cavity 530 has a cross-sectional shape that includes recesses 950 that help grip onto the broach 130. Additionally or alternatively, the cross-sectional shape of the interior can be designed to be universally adaptable to different shaped broaches 130. For example, in the particular version of FIGS. 10A, 10B, 10C, and 10D, the cross-sectional shape is a rounded rectangle cross-section 955 and in the particular version shown is a rounded square cross-section 960. The rounded square cross-section 960 is a curved square or a square with rounded corners. The curved square has four sides that are straighter than four corner portions, with the four sides being generally straight or slightly curved and with the four corner portions being sharp corners or gentle curves. The curved square is able to effectively clamp onto various shaped broaches 130, including circular, oval, square, and rectangular broaches.

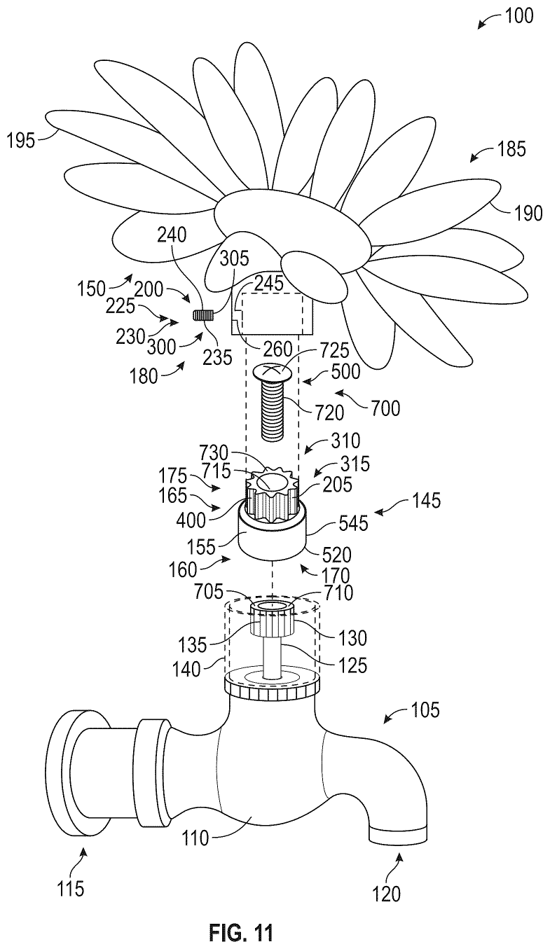

FIG. 11 shows a version of the hose bib handle replacement system 100 of the invention with an adapter 145 of the type shown in FIGS. 10A, 10B, 10C, and 10D. The use the hose bib handle replacement adapter 100 of the invention, a user will first remove an existing handle from its broach 130 by unscrewing the threaded broach connector 720 or broach screw and removing the original handle and retaining the threaded broach connector 720. The adapter 145 is then placed over the broach 130 so that the broach 130 is received within the interior cavity 530 of the adapter 145. Optionally, the adapter 145 may be pressed gently but firmly onto the broach 130. The threaded broach connector 720 is then advanced through the adapter's longitudinal passageway 715 and back into the threaded broach opening 710 where it is tightened to clamp the adapter 145 onto the broach 130. The handle 150 is then attached to the handle connecting portion 165 of the adapter 145 in any of the manner and mechanisms described above. Alternatively, the handle 150 can be pre-attached to the adapter 145, in which case, the passageway 715 can either also extend through the handle 150 or a transverse clamping mechanism 505 can be used.

Although the hose bib handle replacement system 100 and adapter 145 have been described and exemplified for the purpose of replacing a hose bib handle, the system and adapter can also be used to replace any type of faucet handle.

Although the present invention has been described in considerable detail with regard to certain preferred versions thereof, other versions are possible, and alterations, permutations and equivalents of the versions shown will become apparent to those skilled in the art upon a reading of the specification and study of the drawings. For example, the cooperating components may be reversed or provided in additional or fewer number, and all directional limitations, such as up and down and the like, can be switched, reversed, or changed as long as doing so is not prohibited by the language herein with regard to a particular version of the invention. Like numerals represent like parts from figure to figure. When the same reference number has been used in multiple figures, the discussion associated with that reference number in one figure is intended to be applicable to the additional figure(s) in which it is used, so long as doing so is not prohibited by explicit language with reference to one of the figures. Also, the various features of the versions herein can be combined in various ways to provide additional versions of the present invention. Furthermore, certain terminology has been used for the purposes of descriptive clarity, and not to limit the present invention. Throughout this specification and any claims appended hereto, unless the context makes it clear otherwise, the term “comprise” and its variations such as “comprises” and “comprising” should be understood to imply the inclusion of a stated element, limitation, or step but not the exclusion of any other elements, limitations, or steps. Throughout this specification and any claims appended hereto, unless the context makes it clear otherwise, the term “consisting of” and “consisting essentially of” should be understood to imply the inclusion of a stated element, limitation, or step and the exclusion of any other elements, limitations, or steps or the exclusion of any other essential elements, limitations, or steps, respectively. Throughout the specification, any discussion of a combination of elements, limitations, or steps should be understood to include (i) each element, limitation, or step of the combination alone, (ii) each element, limitation, or step of the combination with any one or more other element, limitation, or step of the combination, (iii) an inclusion of additional elements, limitations, or steps (i.e. the combination may comprise one or more additional elements, limitations, or steps), and/or (iv) an exclusion of additional elements, limitations, or steps or an exclusion of essential additional elements, limitations, or steps (i.e. the combination may consist of or consist essentially of the disclosed combination or parts of the combination). All numerical values, unless otherwise made clear in the disclosure or prosecution, include either the exact value or approximations in the vicinity of the stated numerical values, such as for example about +/−ten percent or as would be recognized by a person or ordinary skill in the art in the disclosed context. The same is true for the use of the terms such as about, substantially, and the like. Also, for any numerical ranges given, unless otherwise made clear in the disclosure, during prosecution, or by being explicitly set forth in a claim, the ranges include either the exact range or approximations in the vicinity of the values at one or both of the ends of the range. When multiple ranges are provided, the disclosed ranges are intended to include any combinations of ends of the ranges with one another and including zero and infinity as possible ends of the ranges. Therefore, any appended or later filed claims should not be limited to the description of the preferred versions contained herein and should include all such alterations, permutations, and equivalents as fall within the true spirit and scope of the present invention.

What is claimed is:

1. A hose bib handle replacement adapter, the adapter comprising:
an adapter body comprising a top having an opening, a bottom having an opening, and a passageway extending through the adapter body from the top opening to the bottom opening,
wherein the passageway includes an interior cavity at the bottom end of the adapter body, the interior cavity being sized to at least partially receive a broach of a hose bib, wherein the interior wall of the interior cavity is tapered to accommodate different sized broaches, and
wherein the passageway is adapted to receive a threaded broach connector that has been inserted into the top opening and inserted into a broach threaded opening when the broach is received in the interior cavity of the adapter body.

2. An adapter according to claim 1 wherein the adapter body includes a seating surface adapted to contact a head of the threaded broach connector.

3. An adapter according to claim 1 wherein the interior wall of the interior cavity comprises one or more recesses.

4. An adapter according to claim 1 wherein the interior wall of the interior cavity has a circular cross section.

5. An adapter according to claim 1 wherein the interior wall of the interior cavity has a rounded square cross section.

6. An adapter according to claim 1 wherein the interior wall of the interior cavity has a rounded square cross section and wherein the interior wall has one or more recesses.

7. An adapter according to claim 1 wherein the top of the adapter body comprises a handle connecting portion.

8. An adapter according to claim 1 wherein the top of the adapter body comprises a handle connecting portion that comprises a shaft portion that forms part of a handle connecting mechanism adapted to connect a handle to the handle connecting portion.

9. An adapter according to claim 1 wherein the top of the adapter body comprises a handle connecting portion that comprises a shaft portion having an outer surface adapted to be contacted by a set screw of a connection member of a handle.

10. An adapter according to claim 1 wherein the top of the adapter body comprises a handle connecting portion that comprises a shaft portion having an outer surface adapted to be contacted by a set screw of a connection member of a handle, wherein the outer surface has one or more recesses adapted to cooperate with the set screw to prevent rotation between the adapter and the handle when the handle is connected to the adapter.

11. An adapter according to claim 1 wherein the top of the adapter body is attached to a handle.

12. A hose bib handle replacement system, the system comprising:
a replacement handle adapted to be releasably connected to an adapter;
an adapter having an adapter body comprising a top having an opening, a bottom having an opening, and a passageway extending through the adapter body from the top opening to the bottom opening, wherein the passageway includes an interior cavity at the bottom end of the adapter body, the interior cavity being sized to at least partially receive a broach of a hose bib, wherein the passageway is adapted to receive a threaded broach connector that has been inserted into the top opening and inserted into a broach threaded opening when the broach is received in the interior cavity of the adapter body; and
a connection mechanism adapted to releasably connect the replacement handle to the adapter body, wherein the connection mechanism comprises one or more set screws, one or more threaded openings through a portion of the replacement handle or the adapter body, and a surface on the other of the replacement handle and the adapter body, wherein the surface is adapted to be contacted by an end surface of the one or more set screws to connect the replacement handle to the adapter, and wherein the surface comprises one or more recesses adapted to cooperate with the set screw to prevent rotation between the adapter and the replacement handle when the replacement handle is connect to the adapter.

13. A system according to claim 12 wherein the connection mechanism comprises three set screws and three threaded openings spaced about 120 degrees from one another.

14. A system according to claim 12 wherein the interior wall of the interior cavity is tapered to accommodate different sized broaches.

15. An adapter according to claim 12 wherein the interior wall of the interior cavity has a rounded square cross section.

16. A method of installing a hose bib handle, the method comprising:
providing a handle adapted to be connected to a hose bib;
providing an adapter having an adapter body comprising a top having an opening, a bottom having an opening, and a passageway extending through the adapter body from the top opening to the bottom opening, wherein the passageway includes an interior cavity at the bottom end of the adapter body, the interior cavity being sized and shaped to at least partially receive a broach of a hose bib in a manner that different sized broaches can be received;
positioning the adapter on a broach so that the broach is at least partially receiving in the interior cavity;
inserting a threaded broach connector into the passageway and into a threaded broach opening to connect the adapted to the broach; and
connecting the handle to the adapter body.

17. A method according to claim 16 wherein the hose bib is equipped with a frost-prevention collar.

18. A method according to claim 16 wherein manner that different sized broached can be received comprises the interior wall of the interior cavity being tapered to accommodate different sized broaches.
